(19) United States
(12) Patent Application Publication
(10) Pub. No.: US 2007/0237572 A1
(43) Pub. Date: Oct. 11, 2007

(54) PORTABLE ARTICULATIONG TOOL SUPPORT

(75) Inventor: Gordon Daniel Thiessen, Burnaby (CA)

Correspondence Address: FASKEN MARTINEAU DUMOULIN, LLP, 2100 - 1075 WEST GEORGIA STREET, VANCOUVER, BC, V6E-3G2, CA

(73) Assignee: British Columbia Institute of Technology, Burnaby (CA)

(21) Appl. No.: 11/737,567

(22) Filed: Apr. 19, 2007

Related U.S. Application Data
(63) Continuation-in-part of application No. 11/060,612, filed on Feb. 18, 2005.

(51) Int. Cl. F16D 1/12

(52) U.S. Cl. 403/96

(57) ABSTRACT

A portable multiple-component articulating support apparatus for engaging, moving, orientating and manipulating a hand-operated power tool within and throughout a three-dimensional workspace. The apparatus includes a clamping device for demountable engagement with a structural element, one or more elongate double-axis hinge member, one or more spacer elements having opposite ends adapted for detachable engagement and rotational communication with the clamping device and the double-axis hinge member, a vertically disposed pivotably connected counterbalance arm assembly adapted for detachable engagement and rotational communication with the double-axis hinge member. The counterbalance arm assembly is equipped with a gas-charged cylinder for balancing the weight of hand-operated power tools. The clamping device, a counterbalance element, one or more spacer elements and one or more double-axis hinge elements alternating therebetween, are interconnected with removable hinge pins. A tool-mounting bracket is provided for grippingly engaging a power tool. The tool-mounting bracket pivotably engages a power tool-bearing member which slidingly and rotatably communicates with the counterbalance arm assembly.

### CROSS-REFERENCE TO RELATED APPLICATION

This application is a continuation-in-part of my prior application Ser. No. 11/060,612 filed Feb. 18, 2005, currently pending.

### FIELD OF THE INVENTION

The present invention relates to articulating supports for hand power tools, and more particularly, to portable articulating supports for manual-controlled movement and operation of hand power tools within and throughout three-dimensional work spaces.

### BACKGROUND OF THE INVENTION

Electric and pneumatic-powered hand power tools such as jackhammers, hammer drills, air hammers, impact wrenches and reciprocating saws among others, are commonly used in construction and demolition industries, in heavy equipment repair, and in under-ground mining activities. The weights of these types of tools range between 4.5 kg (i.e., 10 lbs) to 22.7 kg (i.e., 50 lbs) and in some cases, e.g., jackhammers, may reach 34 kg (i.e., 75 lbs) or more. Such tools typically generate considerable torque and vibratory forces which are transmitted to the operators' hands, arms and bodies making precise manipulation of the tools difficult. Quite often, it is necessary for operators to wield, manipulate, orientate and operate these tools in three-dimensional work spaces that include multiple outward and upward-directed planes, while the tools are being held at elevations ranging from the waistline to above the shoulders. Extended operation of such tools in these positions may cause muscle fatigue and/or numbness in the operators' hands and arms thereby affecting not only operator efficiency, but also their safe handling of the tools. Furthermore, the nature of uses to which such tools are applied often result in the tools being inadvertently jammed, stuck or deflected thereby causing unexpected transmission of torque forces that may cause operators to lose their balance resulting in twisting of their bodies or falls causing injuries.

Multi-component articulating supports for enabling the engagement and manipulation of tools in three-dimensional work spaces are known. Examples include those disclosed in U.S. patent application publication US 2004/0026584 to Libbey et al., published on Feb. 12, 2004; PCT application WO 00/16950 to Casun AB Bygg Och Industriservice, published on Mar. 30, 2000; and European Patent Application 0 192 253 A1 to Construction Robotics, Inc. published on Aug. 27, 1986.

The proximal ends of these types of supports are typically securely and permanently fastened to structural members or platforms that are integral components of the work spaces or alternatively, are mounted to transportable platforms, e.g., truck beds or trailers. The distal ends of these supports are provided with tool-engaging devices that securely clamp onto power tools. The tool-engaging devices may be permanently positioned in pre-set orientations, or alternatively, may provide limited movement of the tools in one plane, e.g., a vertical arc or a horizontal arc. Typically, theses types of tool supports are comprised of pluralities of members that are pivotably connected to: (a) each other, (b) to structural elements at the proximal ends of the supports, and (c) to tool-engaging devices at the distal ends of the supports. Most commonly, the first member adjacent the distal end of the support is an articulated arm adapted to move in a vertical plane, and is equipped with a weight-balancing and/or positional control means for a power tool clamped to its distal end. The first member is pivotably connected to a second member whereby the first member can swing in a horizontal arc around its connection point to the second member. The second member is usually pivotably connected to a structural element at the proximal end of the support whereby the second member can swing in limited horizontal arc around its connection point to the structural element. Some articulated supports provide one or more additional members inserted between the first and second member, with each member pivotably connected to its adjacent members thereby enabling each member to swing in a limited horizontal arc around its connection points. Positioning of the tools within three-dimensional workspaces is accomplished by concurrent (a) lateral movements of the members through horizontal arcs around their connection points, and (b) vertical movements of the first members adjacent the distal end of the supports.

The known multi-component articulating supports are typically permanently assembled by means of secured pivot shafts connecting adjacent members, most commonly through clevis-type brackets that are integral to the member bodies. The width of the member bodies restricts the horizontal arc movement of adjacent members, i.e., to about 270° or less, so that adjacent members cannot be completely folded against each other. The rugged nature of the tool-engaging devices and their connection to the first members provide only limited operator-controlled positioning and manipulation of hand power tools relative to the first members. Consequently, such supports are not suitable for use in three-dimensional workspaces where space is restricted or limited and where the tools must be manipulated in multiple radial outward and upward orientations relative to the first member. Another disadvantage is that, due to the permanent assembly of the supports, they can not be easily modified to extend or reduce their scope of movement through disassembly and the addition or removal of one or more members. Furthermore, due to the secure fastenings required to attach the distal ends of the supports to structural members in order to provide stability to the supports when in use, they are not portable, i.e., quickly and easily dismounted from the structural member for transport.

There is a need therefore, to improve the adaptability and maneuverability of multiple-component articulating supports for hand power tools within and throughout restricted three-dimensional workspaces, and the portability of such supports within and between jobsites.

### SUMMARY OF THE INVENTION

It is an object of the present invention, at least in preferred forms, to provide a portable articulating support for improving ease-of-use of hand-operated power tools within and throughout three-dimensional work spaces, and which can be quickly assembled for use, then disassembled for storage or transport.

According to one aspect of the present invention, there is provided a portable articulating support apparatus for supporting a hand-manipulated power tool while allowing movement of the tool in three dimensions, the apparatus comprising: a mounting device for the apparatus capable of disengageable attachment to a support element; one or more hinge members each having two opposed spaced-apart parallel bores for receiving hinge pins therein; a tool holder capable of engaging and supporting a hand-operated power tool while allowing swivelling of said tool about horizontal and vertical axes; one or more spacer elements; a counterbalance element having opposite ends, with one end detachably engaged with one said hinge member and an opposite end engaged with the tool holder, said opposite end being movable in a vertical plane while said one end is supported by said one hinge member, and having a balancing arrangement generating a force counteracting weight applied to said one end by said tool holder. A portable articulating support apparatus for supporting a hand-manipulated power tool while allowing movement of the tool in three dimensions, the apparatus comprising: a mounting device for the apparatus capable of disengageable attachment to a support element; one or more hinge members each having two opposed spaced-apart parallel bores for receiving hinge pins therein; a tool holder capable of engaging and supporting a hand-operated power tool while allowing swivelling of said tool about horizontal and vertical axes; one or more spacer elements; a counterbalance element having opposite ends, with one end detachably engaged with one said hinge member and an opposite end engaged with the tool holder, said opposite end being movable in a vertical plane while said one end is supported by said one hinge member, and having a balancing arrangement generating a force counteracting weight applied to said one end by said tool holder; wherein said mounting device, said one or more spacer elements, said one or more hinge members and said counterbalance element are arranged to form interconnecting parts of an articulating arm having said mounting device at one end of the articulating arm, said counterbalance element at an opposite end of the articulating arm, and said one or more spacer elements and said one or more hinge members alternating therebetween; and a plurality of vertically disposed hinge pins passing through vertically aligned bores, including said spaced, parallel bores of said one or more hinge members, in said interconnecting parts of said articulating arm to allow pivotal rotation of said parts around said hinge pins, at least one of said hinge pins being slidably removable from one said bores and having an enlarged head at an upper end thereof shaped to be graspable by hand to facilitate complete removal of said pin, thereby allowing at least partial disassembly of said articulating arm for ease of transportation of said apparatus.

According to another aspect of the invention, there is provided portable articulating support apparatus for supporting a hand-operated power tool while allowing movement of the tool in three dimensions, the apparatus comprising: a mounting device capable of disengageable attachment to a support element; a hinge member having two juxtaposed bores for receiving hinge pins therethrough; a tool holder capable of engaging and supporting a hand-operated power tool while allowing swivelling of said tool about horizontal and vertical axes; a spacer arm having opposite ends with one end detachably engaged with the mounting device, and another end detachably engaged with the hinge member; and a counterbalance arm having opposite ends, with one end detachably engaged with the hinge member and an opposite end detachably engaged with the tool holder, said opposite end being movable in a vertical plane while said one end is supported by said hinge element, and having a balancing arrangement generating a force counteracting weight applied to said one end by said tool holder; wherein said mounting device, spacer arm, hinge member and counterbalance arm are detachably and rotatably engaged one with another by a plurality of removable vertically disposed hinge pins passing through vertically aligned bores in overlapping parts of said mounting device, spacer arm, hinge member and counterbalance arm, said removable hinge pins having enlarged heads at upper ends thereof shaped to be graspable by hand to facilitate complete removal of the pins from said bores, thereby allowing separation of said mounting device, spacer arm, hinge member and counterbalance arm for ease of replacement, storage and transport thereof.

According to yet another aspect of the invention, there is provided a tool holder for supporting a power tool from an articulating arm while allowing movement of the tool in three dimensions, the holder comprising: a tool-mounting bracket equipped with a tool-clamping device; a bracket support connected to said tool-mounting bracket while allowing the bracket to swivel around a horizontal axis; and a load-bearing shaft interconnected with the bracket support, said shaft being capable of attachment to a movable support while permitting swivelling of said tool holder about a vertical axis.

In a preferred form, the invention provides a multiple-component articulating tool support wherein the components are detachably engaged with removable hinge pins. The tool support has a proximal end and a distal end wherein a clamping device is provided at the proximal end for demountably engaging a structural support element, and a vertically disposed counterbalance arm assembly is provided at the distal end for slidingly receiving and supporting therein a tool-bearing member. The counterbalance arm assembly is preferably provided with a gas-charged cylinder for balancing and supporting the weight of a hand-operated power tool, and is configured to pivotably move in a vertical axis. There is also provided a double-axis hinge component configured to receive therethrough two opposing removable hinge pins for detachably engaging the counterbalance arm assembly and one or more spacer arms intermediate the clamping device. The spacer arm can be detachably engaged with the clamping device or alternatively, the spacer arm can be detachably engaged to a double-axis hinge which is also detachably engaged with the clamping device. The components of this invention can easily be moved rotatably around the removable hinge pins by which they are detachably engaged so that the components can be folded tightly together, partially folded, or unfolded so that the combination of components form a straight line. A hand-operated power tool mounted in the tool-bearing member can easily be moved, orientated, manipulated, and operated within and throughout a three-dimensional workspace with minimal physical exertion.

In another preferred form, the invention provides a tool-mounting bracket for communicating with the tool-bearing member wherein the tool-mounting bracket comprises two opposing plates integrally conjoined by a bottom plate. The bottom plate is provided with a bore for a clamping device to grippingly engage a hand-operated power tool therethrough. The opposing plates are provided with one or more pairs of aligned bores for receiving therein connecting devices for pivotably communicating with the tool-bearing member.

In another preferred form, the invention provides a tool-bearing member in the form of an elongate continuous loop provided with one or more pairs of aligned opposing sleeves for receiving therein connecting devices for pivotably communicating with the tool mounting bracket. The elongate continuous loop is integrally connected at one end to a load-bearing shaft for slidingly and rotatably communicating with the counterbalance arm assembly. A stop collar is provided for demountable engagement with the load-bearing shaft. The tool-bearing member can be inserted into the counterbalance arm assembly from above whereby the stop collar rotatably communicates with the arm assembly. Alternatively, the tool-bearing member can be inserted into the counterbalance arm assembly from below whereby the stop collar is engaged with the portion of load-bearing shaft protruding from the top of the counterbalance arm assembly, thereby suspending the tool-bearing member below the counterbalance arm assembly.

In another preferred form, the invention provides a tool-bearing member in the form of a rod assembly comprised of a load-bearing shaft connected at one end to a universal joint. The universal joint is also connected to a tool-bearing shaft having a threaded bore in its free end for grippingly engaging therein the clamping device of the tool-mounting bracket. The load-bearing shaft is inserted into the counterbalance arm assembly from below whereby the stop collar is engaged with the portion of load-bearing shaft protruding from the top of the counterbalance arm assembly, thereby suspending the tool-bearing member below the counterbalance arm assembly.

In still another preferred form, the invention provides a plurality of devices for retaining power cords adjacent the counterbalance arm assembly and the spacer arms.

### BRIEF DESCRIPTION OF THE DRAWINGS

The present invention will be described in conjunction with reference to the following drawings in which:

FIG. 1 is a perspective view of one embodiment of the portable articulating tool support of the present invention;

FIG. 2 is a partial view of the proximal end of the embodiment shown in FIG. 1;

FIG. 3 is a partial view of the distal end of the embodiment shown in FIG. 1;

FIG. 4 is a perspective view of another embodiment of the portable articulating tool support of the present invention;

FIGS. 5a and 5b are a side view and bottom view of a preferred embodiment of the tool bracket component of the portable articulating tool support of the present invention;

FIG. 5c is a side view of a pin that cooperates with the tool bracket shown in FIGS. 5a and 5b;

FIG. 6 is a view of another component of the portable articulating tool support of the present invention;

FIG. 7 shows the component of FIG. 6 cooperating with another component at the distal end of the present invention;

FIG. 8 is a view of an alternative component to the component shown in FIG. 6;

FIG. 9 shows the component of FIG. 8 cooperating with another component at the distal end of the present invention;

FIGS. 10a and 10b show two embodiments for another component of the portable articulating tool support of the present invention;

FIG. 11 is a side view of the embodiment of the present invention shown in FIG. 4.

FIG. 12 is a side view of the counterbalance element engaged and cooperating with another exemplary embodiment of the tool support of the present invention;

FIG. 13 is a front view of the tool support shown in FIG. 12;

FIGS. 14a, 14b and 14c are close-up partial cross-sectional side views of alternative embodiment of the distal end of the counterbalance element: (a) locked in a downward-extending position, (b) locked in a horizontal position, and (c) locked in an upward-extending position;

FIGS. 15a, 15b and 15c are views of another preferred embodiment of the tool bracket component of the portable articulating tool support of the present invention, showing: (a) a right side view, (b) a left side view, and (c) a perspective view from the right front;

FIG. 16 is a perspective view of another preferred embodiment of the mounting device component of the portable articulating tool support of the present invention, in a locked-on engagement with a support; and

FIG. 17 is a perspective view of the mounting device component from FIG. 16, shown un-locked from the support.

### DETAILED DESCRIPTION OF THE INVENTION

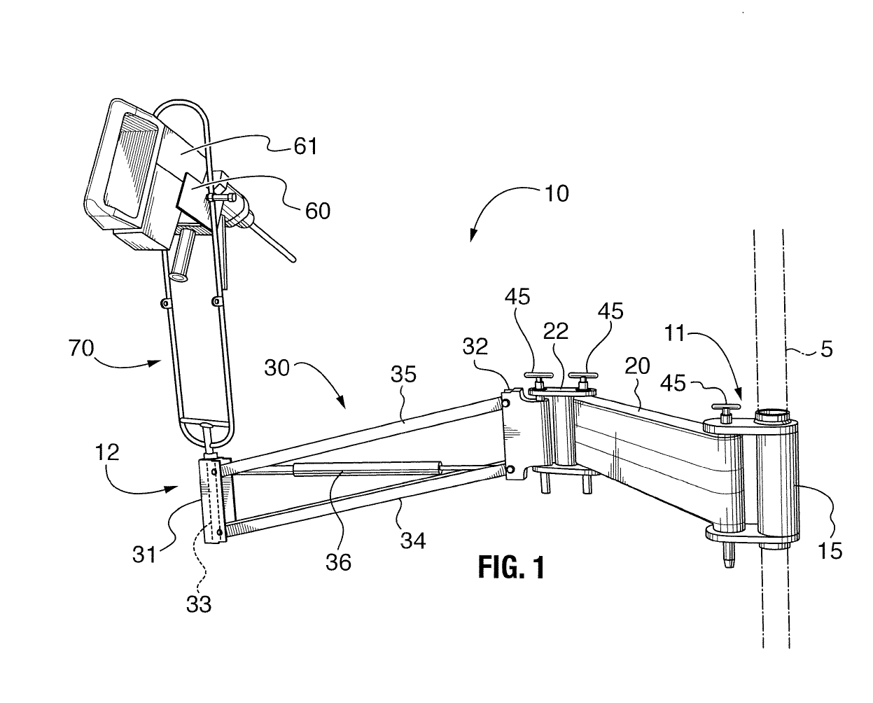

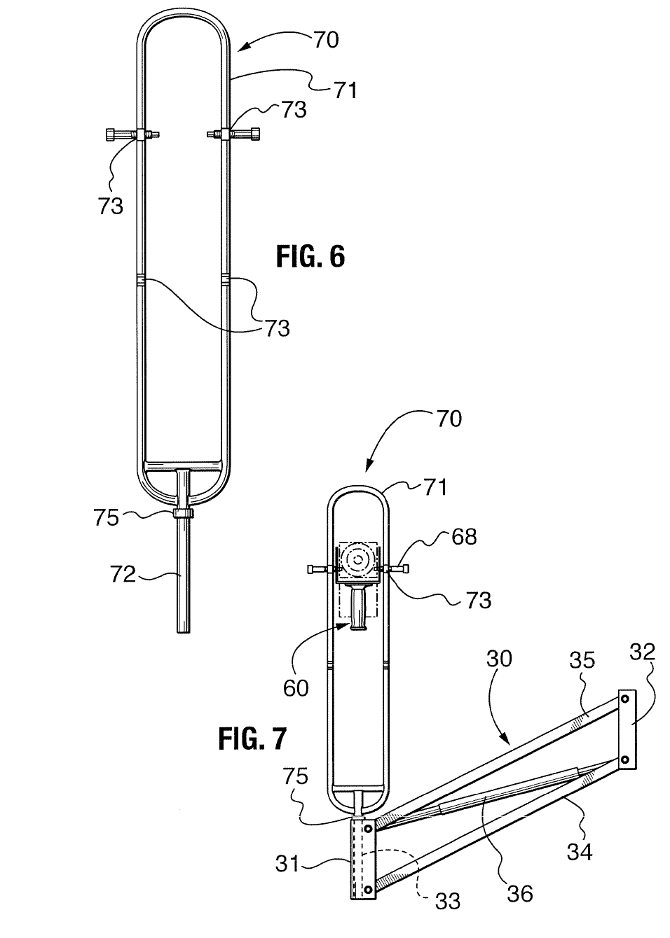

As shown in FIG. 1 of the accompanying drawings, a preferred embodiment of the present invention comprises a portable, multi-component articulating support apparatus 10 for a hand-manipulated power tool 61, e.g. a rock drill as shown. The support 10 has a proximal end 11 and a distal end 12, and is equipped with a mounting device 15 for detachable engagement with a support element 5 at proximal end 11. Mounting device 15 is detachably coupled to the proximal end of an elongated spacer element 20 by means of a hinge pin 45, while the distal end of spacer element 20 is detachably coupled to one side of double-axis hinge element 22 by means of another hinge pin 45. The distal end 12 of support apparatus 10 includes an articulating elongated counterbalance element 30 detachably coupled to the other side of double-axis hinge element 22 by means of another hinge pin 45. Articulating counterbalance element 30 has a distal bracket 31 and a proximal bracket 32, both pivotably connected to a lower control rod 34 and an upper control rod 35 whereby distal bracket 31, proximal bracket 32, lower control rod 34 and upper control rod 35 form an articulating parallelogram. Located diagonally within the articulating parallelogram is a balancing arrangement 36 in the form of a gas-charged cylinder interconnected between proximal bracket 31 and distal bracket 32 using the same rotatable attachment points as the respective ends of control rods 34 and 35. Distal bracket 31 is provided with shaft receptacle 33 coincident with its longitudinal axis for slidingly and rotatably receiving a load-bearing shaft 72 (see FIG. 6) which is integrally connected to tool holder 70 which includes a tool-mounting bracket 60 and a bracket support 71 in the form of a continuous wire loop as shown. Hand-manipulated power tool 61 is securely held within the tool-mounting bracket 60 which, in turn, is pivotably held within tool holder 70. The balancing arrangement 36 in the form of the gas-charged cylinder provides weight-balancing support for power tool 61 enabling the tool to be suspended hands-free at an elevation at which the force generated by the cylinder balances the weight of the tool and tool holder. The distal end of the counterbalance element 30 is movable in a vertical plane by virtue of the articulation of rods 34 and 35 while the proximal end remains at the height of hinge member 22. The operator can therefore raise or lower the tool and tool holder from the position of counterbalance by applying minimal force without having to support the full weight of the tool.

The tool holder 70 also allows the tool 61 to be swivelled about a horizontal axis where the bracket 60 is mounted within the bracket support 71, and about a vertical axis where the load-bearing shaft 72 fits within shaft receptacle 33.

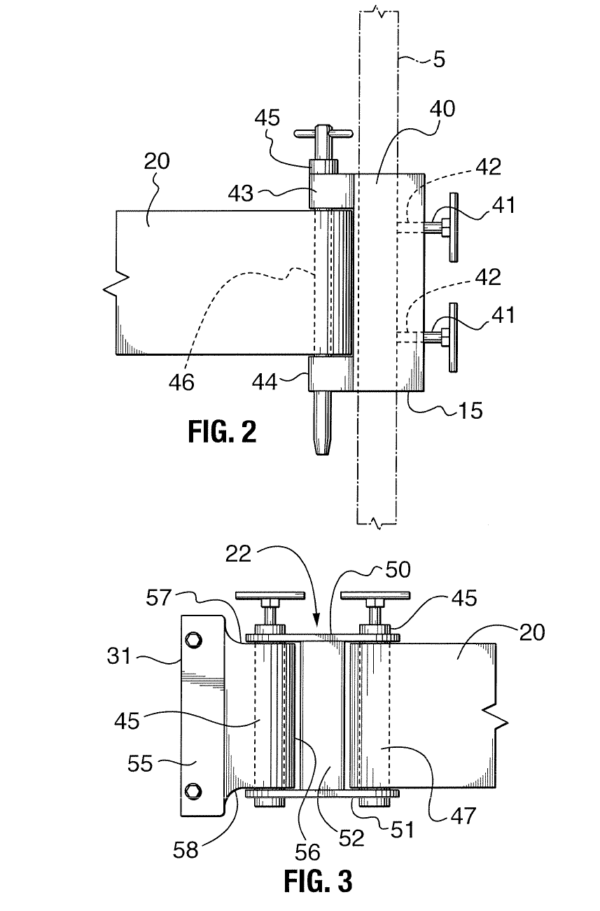

As shown more clearly in FIG. 2, mounting device 15 is provided with a sleeve 40 sized to slip over and slide along a support element 5, e.g. a scaffold bar or an upright bar supported on a movable base member (not shown). Mounting device 15 is provided with tightening devices for rigidly connecting sleeve 40 with support element 5. In this preferred embodiment for example, threaded bolts 41 are screwed into and through threaded bores 42 in the sleeve 40 to bear against the structural element 5. The position of mounting device 15 along the vertical axis of support element 5 can be quickly and easily changed by loosening the threaded bolts 41, thereby disengaging structural element 5 from sleeve 40, moving mounting device 15 to a different selected position, and then re-engaging support element 5 by re-tightening bolts 41. It should be noted that other devices can be provided for engaging mounting device 15 with support element 5. For example, threaded bolts 41 may be replaced by spring loaded pins slidingly communicating with unthreaded bores for releasably engaging support element 5, or alternatively, clamping devices may be provided for engaging the wall of sleeve 40 with support element 5. It should also be noted that sleeve 40 can be shaped to slidingly communicate with solid or tubular structural elements having circular cross-sections, or alternatively, square, rectangular or other cross-sections. Mounting device 15 is also provided with upper and lower brackets 43 and 44, respectively, both having bores aligned with a common vertical axis for receiving graspable hinge pin 45 therethrough. Proximal end of a spacer element 20 fits within a gap formed between brackets 43 and 44 to form overlapping parts. The proximal end of the spacer element 20 is supported by the upper surface of lower bracket 44, and is provided with bore 46 for receiving hinge pin 45 therethrough. Thus, the proximal end of spacer element 20 is detachably coupled to mounting device 15 by means of sliding hinge pin 45 passing through the bore on upper bracket 43, through bore 46 at the proximal end of spacer element 20, and then through the bore on lower bracket 44 thereby enabling spacer element 20 to rotate in a horizontal arc around the non-rotatable mounting device 15.

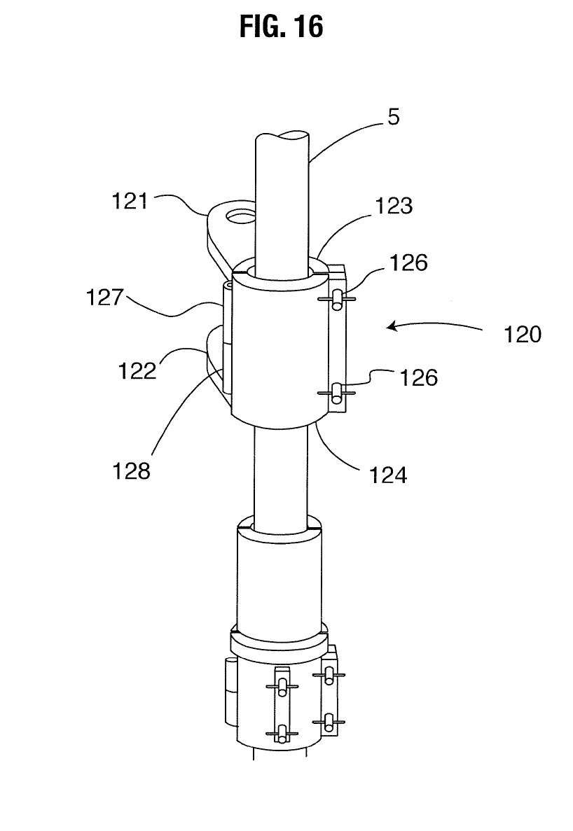

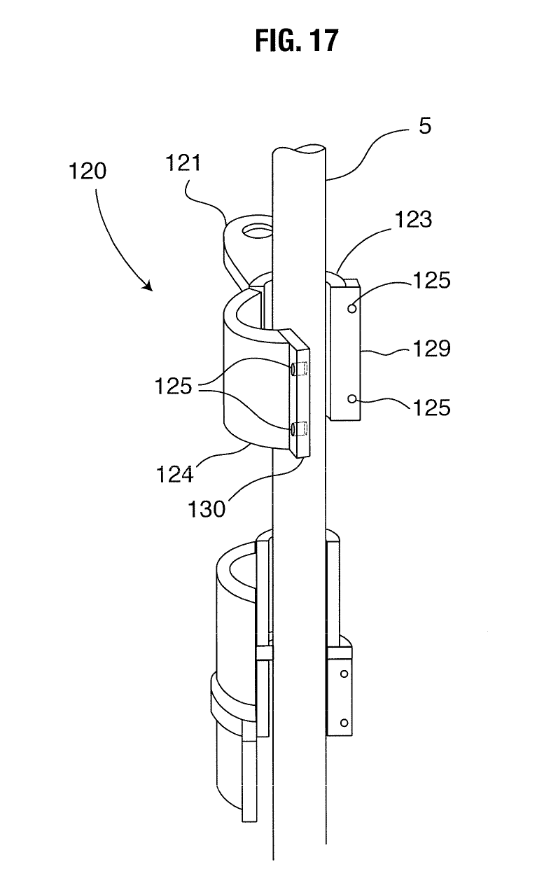

An alternative exemplary mounting device 120 is shown in FIGS. 16 and 17 generally configured as a “quick-release” hinged clam-shell clamp having two opposing elongate brackets 123 and 124 that, when abutted together, define a bore therethrough. The diameter of the bore is preferably sized to grippingly engage a standard-sized scaffolding bar and/or shoring pole commonly used in the construction industries. The elongate brackets 123 and 124 of mounting device 120 are provided with cooperating hinge elements along one side of the elongate bracket side edges as exemplified in FIG. 16 by hinge elements 127 and 128. The opposite side edges of the elongate brackets are preferably provided with outward extending lips 129 and 130 (best seen in FIG. 17) through which are provided a pair of matching bores 125 configured for receiving therethrough a pair of locking pins 126. Thus, the exemplary mounting device 120 can be quickly and grippingly engaged with a suitable support element 5 but encircling the support element 5 with the opposing brackets 123 and 124, then locking the mounting device onto the support element by inserting and engaging a pair of locking pins 126 through bores 125. The mounting device 120 can be quickly disengaged from the support element 5 simply by disengaging and removing the locking pins 126 from the bores 125. One of the opposing elongate brackets 123 or 124 (exemplified in FIGS. 16 and 17 as bracket 123) is also provided with upper and lower brackets 121 and 122, respectively, both having bores therethrough aligned with a common vertical axis for receiving graspable hinge pin 45 therethrough. Proximal end of a spacer element 20 fits within a gap formed between brackets 121 and 122 to form overlapping parts. The proximal end of the spacer element 20 is also supported by the upper surface of lower bracket 122. Thus, the proximal end of spacer element 20 is detachably coupled to mounting device 120 by means of sliding hinge pin 45 passing through the bore on upper bracket 121, through bore 46 at the proximal end of spacer element 20, and then through the bore on lower bracket 122 thereby enabling spacer element 20 to rotate in a horizontal arc around the non-rotatable mounting device 120.

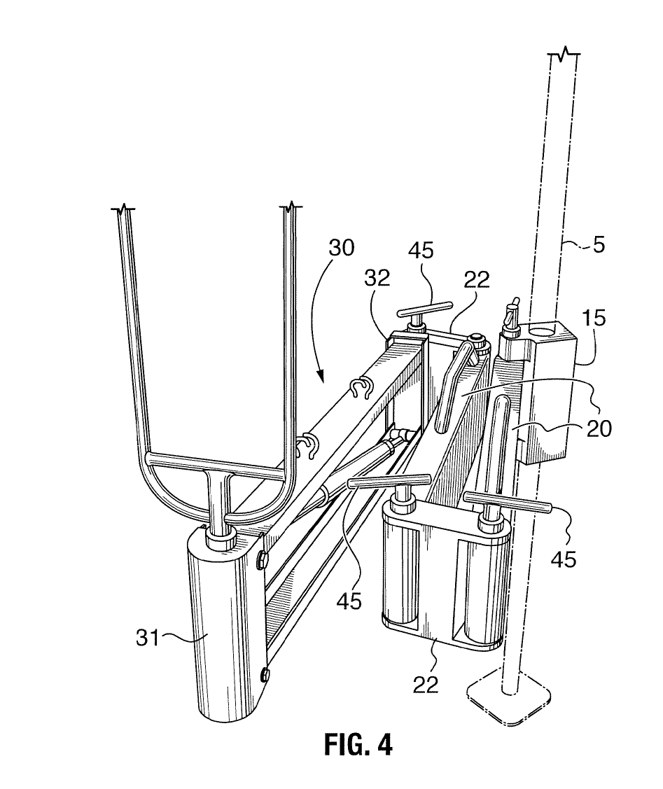

As shown more clearly in FIG. 3, double-axis elongated hinge element 22 has an upper hinge bracket 50 and lower hinge bracket 51 integrally connected by a vertical web 52. The upper hinge bracket 50 is provided with a pair of opposing bores extending therethrough wherein one of the bores is positioned on one side of the vertical web 52 and the other bore is positioned on the other side of the vertical web 52. The lower hinge bracket 51 is also provided with a pair of opposing bores extending therethrough wherein one of the bores is positioned on one side of the vertical web 52 and the other bore is positioned on the other side of the vertical web 52. The pair of bores on the upper hinge bracket 50 (i.e., the upper bores) are aligned with the pair of bores on the lower hinge bracket 51 (i.e., the lower bores). Accordingly, the aligned upper and lower bores (a first set of hinge-unit bores) extending therethrough the upper and lower hinge brackets 50 and 51 on one side of the web 52, are adapted for receiving through both a hinge pin 45 thereby forming one axis of the double-axis elongate hinge element 22. The other aligned upper and lower bores (a second set of hinge-unit bores) extending therethrough the upper and lower hinge brackets 50 and 51 on the other side of the web 52, are also adapted for receiving through both a hinge pin 45 thereby forming the second axis of the double-axis elongate hinge element 22. The distal end of spacer element 20 fits snugly between the upper upper and lower hinge brackets 50 and 51, and is supported by an upper surface of the lower hinge bracket 51. The distal end of spacer element 20 is provided with a bore 47 for receiving a hinge pin 45 therethrough. The distal end of spacer element 20 is thus detachably coupled at respective overlapping parts with double-axis hinge element 22 by sliding hinge pin 45 through the upper bore on upper hinge bracket 50, through bore 47, and then through the corresponding aligned bore on lower bracket 44, i.e. the first set of bores, thereby enabling spacer element 20 to rotate in a horizontal arc around the first axis of the double-axis hinge element 22. Proximal bracket 32 of the counter balance element 30 has opposing vertical flanges 55 connected by vertical web 56 having an upper surface 57 and lower surface 58. The web 56 is provided with a vertical bore 48 for receiving a hinge pin 45 therethrough. The proximal bracket 32 is detachably coupled to the second axis of the double-axis hinge element 22 at the overlapping parts by sliding hinge pin 45 through the bore on upper hinge bracket 50 opposite the bore connected to spacer element 20, through the bores in the vertical web 56, and then through the aligned bore on lower bracket 44, i.e. the first set of bores, thereby enabling proximal bracket 32 to rotate in a horizontal arc around the first axis of the double-axis hinge element 22 and, furthermore, enabling counter balance element 30 to rotate 360° around double-axis hinge element 22 relative to spacer element 20 thereby making it possible to fold the counter balance element 30 flat against either side of spacer element 20 for compact storage as shown in FIG. 4 and for allowing the tooling on the arm to reach positions not otherwise possible with a single axis hinge.

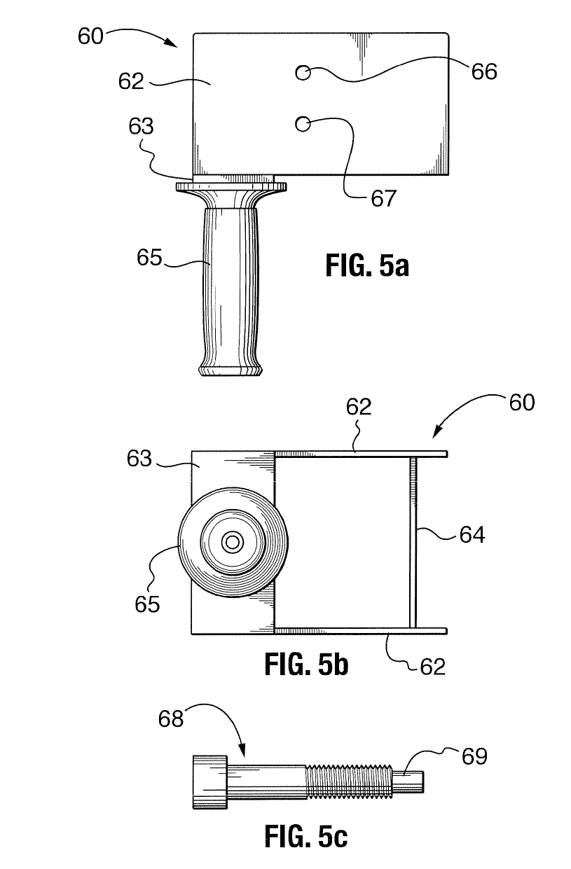

Tool-mounting bracket 60 is exemplified in more detail in FIGS. 5a, 5b, and 5c. The bracket releasably but firmly engages power tool 61 as shown in FIG. 1. In this embodiment, bracket 60 comprises two opposing flanges 62 conjoined by web 63 with bracket 60 stabilized by spacer rib 64 that is welded to the opposing flanges 62. Web 63 has a bore positioned at its centre for receiving therethrough clamping device 65 to firmly secure power tool 61 within bracket 60, e.g. by having a threaded end screwed into a threaded bore positioned within the power tool body. The clamping device 65 may also act as a handle for manipulation of the power tool via bracket 60. Opposing flanges 62 are provided with at least one pair of aligned bores 66. If so desired, one or more additional pairs of bores (e.g., 67) can be added to opposing flanges 62. Threaded bolts 68 with a terminal pin portion 69 are provided for pivotably communicating with aligned bores 66 or 67, thereby allowing the bracket to swivel around a horizontal axis.

Tool holder 70, as exemplified in more detail in FIGS. 6 and 7, has an elongated bracket support 71 consisting of a continuous wire loop integrally connected at one end to load-bearing shaft 72. A pair of opposing sleeves 73 is integrally attached to the loop for slidingly receiving therethrough pin portion 69 of threaded bolt 68, for releasably engaging and pivotably communicating therewith bores 66 or 67 in bracket 60. If so desired, bracket support 71 may be provided with multiple sets of opposing sleeves 73 to provide a variety of positioning to accommodate power tools of different shapes and dimensions. Load-bearing shaft 72 is adapted to slidingly and rotatingly communicate with shaft receptacle 33 of the distal bracket 32 of the counter-balance element 30 shown in FIG. 1. If so desired, a stop collar 75 can be engaged with load-bearing shaft 72 at a selected point to prevent direct contact between the bracket support 71 and distal bracket 32.

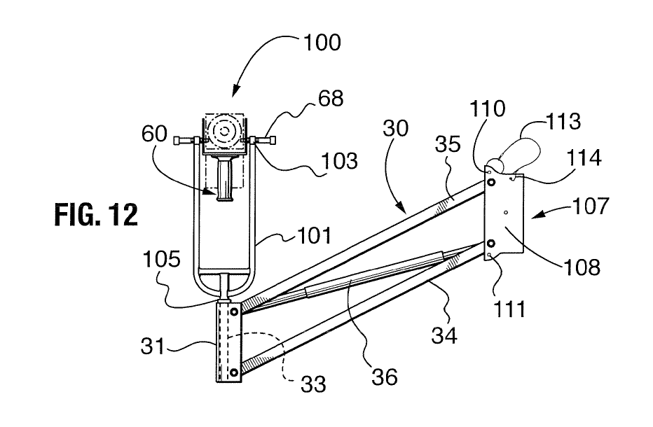

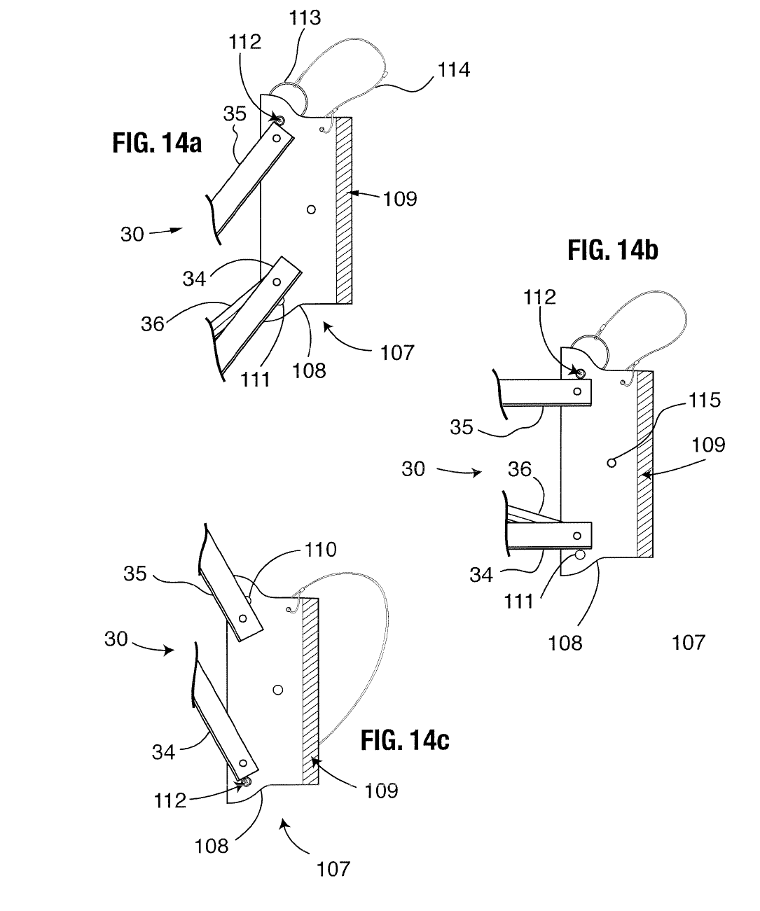

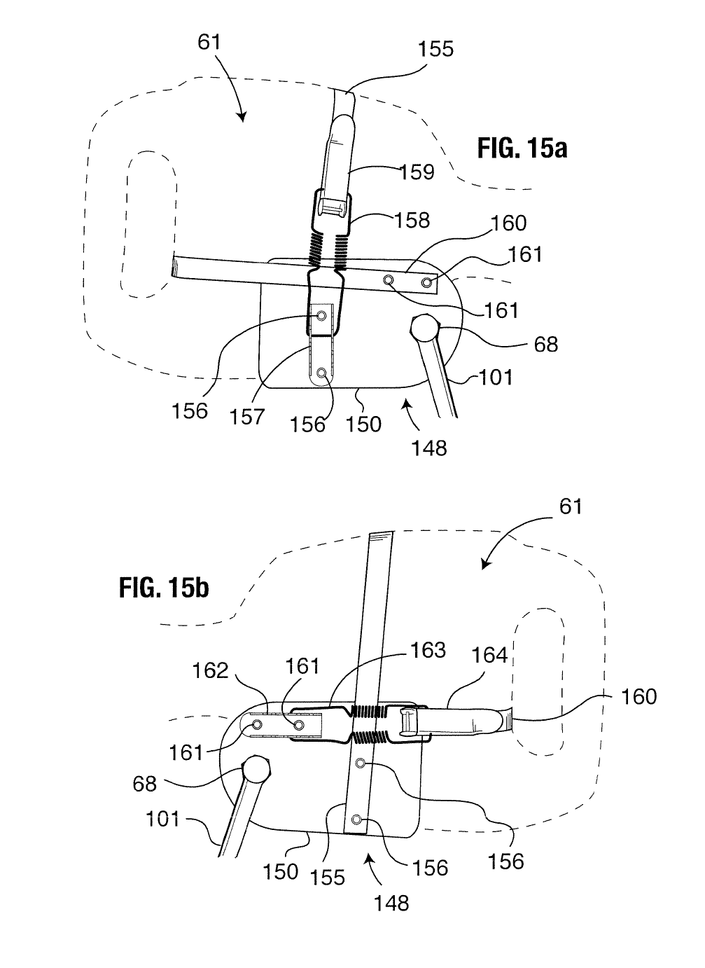

As shown in FIGS. 12, and 14a-14c, the articulating counterbalance element 30 may be optionally provided with an alternative distal bracket 107 comprising a pair of opposing flanges 108 interconnected by a vertically aligned web 109. An upper bore 110 (best seen in FIG. 14c) is provided proximate above the bore (not shown) where through the upper control rod 35 is pivotably connected to the flanges 108 of the distal bracket 107, and a lower bore 111 (best seen in FIGS. 14a and 14b) is provided proximate below the bore (not shown) where through the lower control rod 34 is pivotably connected to the flanges 108 of the distal bracket 107. As shown in FIG. 14a, the counterbalance element 30 may be “locked” with control rods 34 and 35 extending in a downward position by holding the counterbalance element in a position where the end surface of the upper control rod 35 is adjacent bore 110 while inserting a locking pin 112 therethrough bore 110. As shown in FIG. 14ba, the counterbalance element 30 may be “locked” with control rods 34 and 35 extending outward in a horizontal position by holding the counterbalance element in a position where the upper surface of the upper control rod 35 is adjacent bore 110 while inserting a locking pin 112 therethrough bore 110. As shown in FIG. 14c, the counterbalance element 30 may be “locked” with control rods 34 and 35 extending in an upward position by holding the counterbalance element in a position where the end surface of the lower control rod 34 is adjacent bore 111 while inserting a locking pin 112 therethrough bore 111. One end of locking pin 112 may be preferably configured to engagedly communicate with a ring device 113 attached to the distal bracket 107 by a tie device 114. The distal bracket 107 may be optionally provided with a suitably placed bore 115 therethrough opposing flanges 108 for storing the locking pin 112 therein the counterbalance element 30 is being used in an unlocked configuration.

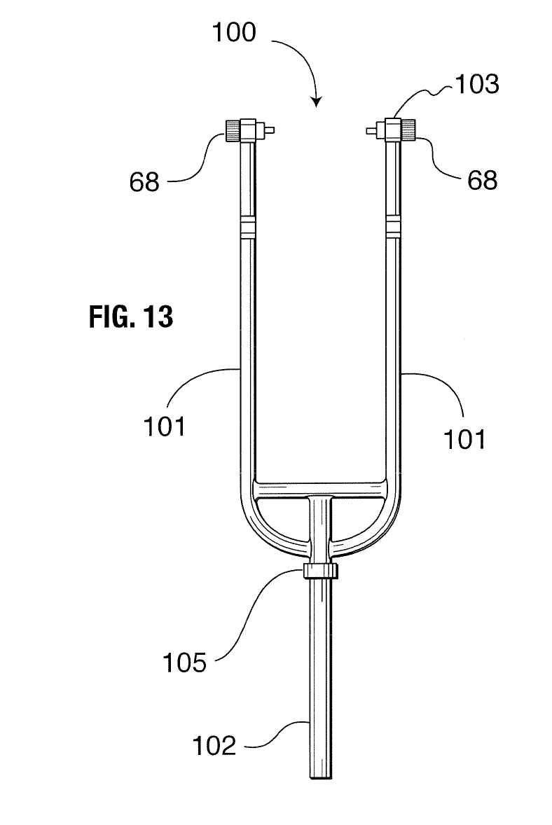

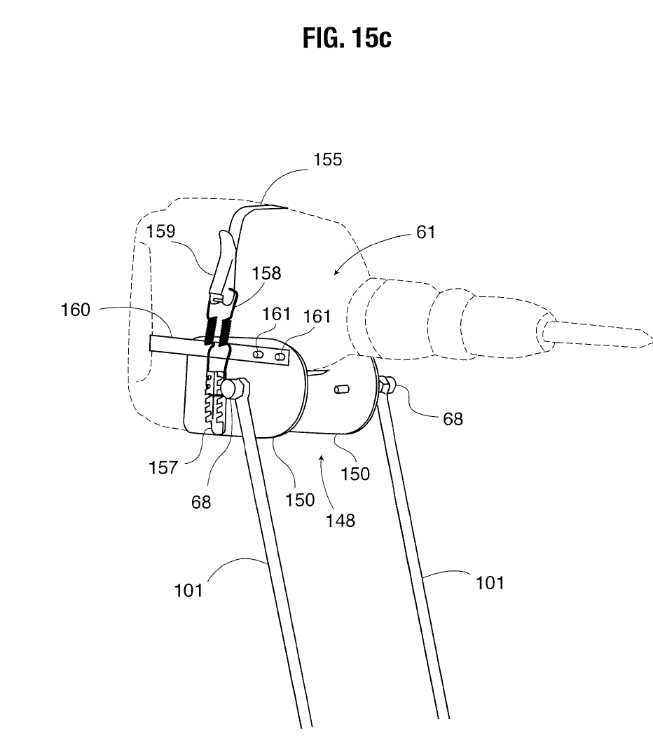

An alternative exemplary embodiment of another suitable tool-mounting bracket 148 is shown in FIGS. 15a, 15b, and 15c. The bracket 148 generally comprises two opposing plates 150 conjoined by a web, a first clamping device engaged with the opposing mounting plates in a first selected plane, and a second clamping device engaged with the opposing mounting plates in a second selected plane orientated at about 90° to the first selected plane. The tool bracket 148 is mountable into a suitable tool holder as exemplified in FIG. 6 by a continuous loop-shaped tool holder 70, and in FIG. 13 by a U-shaped tool holder 100, by pins 68 provided therefore cooperating with opposing sleeves 73 and 103 respectively. The first clamping device comprises a strap 155 mounted to one of the plates 150, preferably with two securing devices 156 such as rivets. A plate 157 configured for releasably receiving and retaining a biasing device 158, is secured to the opposing plate 150, preferably with two securing devices 156 such as rivets. The end of the strap 155 opposite the end secured to the plate 150, is suitably hingedly interconnected with a lever 159 that retains and cooperates with the biasing device 158. When the lever 159 is in a pulled-away position from the strap 155, the biasing device 158 can be easily engaged with or removed from the mounting device 156.

When the biasing device 158 is engaged with the mounting device 157, the lever 159 can then be moved to and locked into a position flat against the strap 155 thereby applying a tension to the biasing device 158 which thereby provides a first clamping force against a tool 61 that is inserted between the two plates 150. The second clamping device comprises a strap 160 mounted to one of the plates 150, preferably with two securing devices 161 such as rivets. A plate 162 configured for releasably receiving and retaining a biasing device 163, is secured to the opposing plate 150, preferably with two securing devices 161 such as rivets. The end of the strap 160 opposite the end secured to the plate 150, is suitably hingedly interconnected with a lever 164 that retains and cooperates with the biasing device 163. When the lever 164 is in a pulled away position from the strap 160, the biasing device 163 can be engaged with or removed from the mounting device 162. When the biasing device 163 is engaged with the mounting device 162, the lever 164 can then be moved to and locked into a position flat against the strap 160 thereby applying a tension to the biasing device which thereby provides a second clamping force against the tool 61 inserted in between the two plates 150. Those skilled in these arts will understand that the components parts of the first and second clamping devices can be identical in configuration and that the only difference is the two clamping devices are mounted to the opposing plates in two different planes. The straps 155 and 160 may comprise any suitable metal or woven strapping material. The plates 157 and 162 are preferably provided with a plurality of spaced-apart opposing channels configured for receiving and retaining therein the biasing devices 158 and 163. If so desired, the plurality of spaced apart channels provided on the plates 157 and 162 may be angled away from the straps 155 and 160. It is suitable for one of the clamping devices to be mounted on opposing plates 150 so that it encircles the body of a tool 61 inserted between the opposing plates 150 as shown in FIGS. 15a and 15b by the first clamping device with strap 155. It is preferable, then, that the second clamping device, i.e., with strap 160, is mounted on opposing plates 150 so that it passes through a handle portion of the tool 61, thereby providing a second clamping force against the tool 61 that cooperates with the first clamping force to securely retain the tool in the tool bracket 148. The tool 61 can be quickly and easily removed from the tool bracket 148 by releasing the cooperating clamping forces by pulling levers 158 and 164 away from straps 155 and 160, then disengaging and removing biasing devices 158 and 163 from plates 157 and 162, after which the tool can be easily removed from the tool bracket 148. The tool

An alternative exemplary tool holder 100 is shown in FIGS. 12 and 13, and generally comprises a U-shaped elongated bracket support comprising two opposed arms 101 integrally connected at one end to load-bearing shaft 102. A pair of opposing sleeves 73 is integrally attached to the two opposed arms 101 for slidingly receiving therethrough pin portions 69 of threaded bolts 68, for releasably engaging and pivotably communicating therewith bores 66 or 67 in the tool bracket 60. The U-shaped elongated bracket support may be suitably configured using materials comprising elongate rods, elongate bars, elongate rails and the like. If so desired, the two opposed arms 101 may be provided with multiple sets of opposing sleeves 103 to provide a variety of positioning to accommodate power tools of different shapes and dimensions. Load-bearing shaft 102 is adapted to slidingly and rotatingly communicate with shaft receptacle 33 of the distal bracket 32 of the counter-balance element 30 shown in FIG. 1. If so desired, a stop collar 105 can be engaged with load-bearing shaft 102 at a selected point to prevent direct contact between the bottom portion of the tool holder 100 interconnecting the opposed arms 101 and distal bracket 32.

It will be apparent from the figures described above that the various elements of the apparatus together form an articulating arm having a mounting device at one end and a counter-balance element, rotatably mounting a tool holder, at an opposite end with the spacer element and the double-axis hinge element therebetween. The various elements of the arm are rotatably attached together at overlapping parts by means of vertically-oriented hinge pins extending through aligned bores in the overlapping parts.

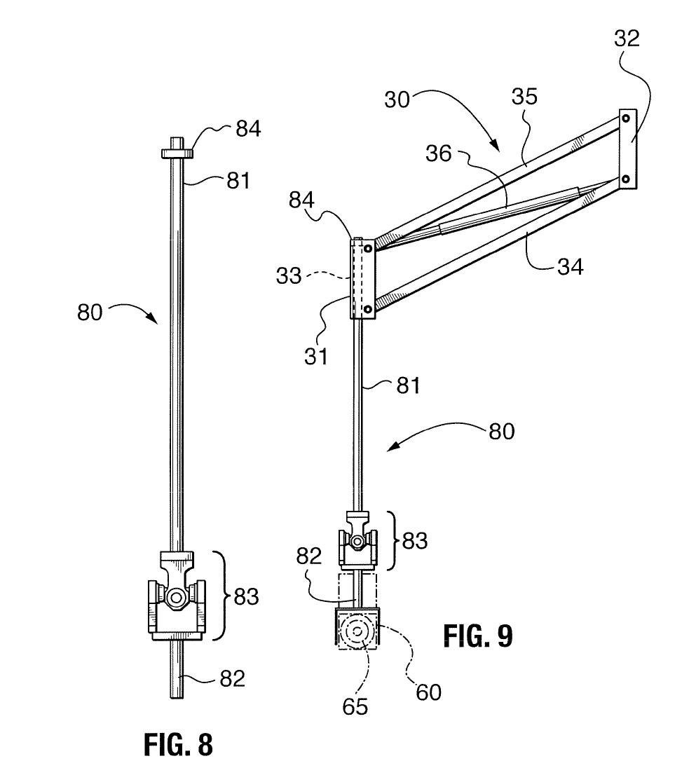

It is preferable in some construction, mining and equipment repair applications, to suspend hand-manipulated power tools underneath the portable multi-component articulating support apparatus of the present invention for ease of access to and manoeuvrability around power tool engagement targets. A preferred embodiment of such an arrangement is shown in FIGS. 8 and 9. In this embodiment, a tool holder 80 is provided in the form of a rod 82 attached at its lower end to tool-clamping device 60, and thus to a power tool 61 (not shown) via a universal joint 83. Tool holder 80 has an upper end 81 adapted to slidingly and rotatably communicate with shaft receptacle 33 of the counter-balance element 30 and a stop collar 84 provided to allow the rod to be suspended from the counter-balance element while allowing for rotation. The lower end of rod 82 is adapted to engage clamping device 60, and the universal joint 83 is intermediate rod 82 and upper end 81. Rod 82 is provided with a threaded bore therein (not shown) for receiving a clamping device of the tool-mounting bracket similar to device 65 of FIGS. 5a and 5b, for pivotably manipulating therefrom power tool 61 (not shown) in multiple planes within a three-dimensional workspace.

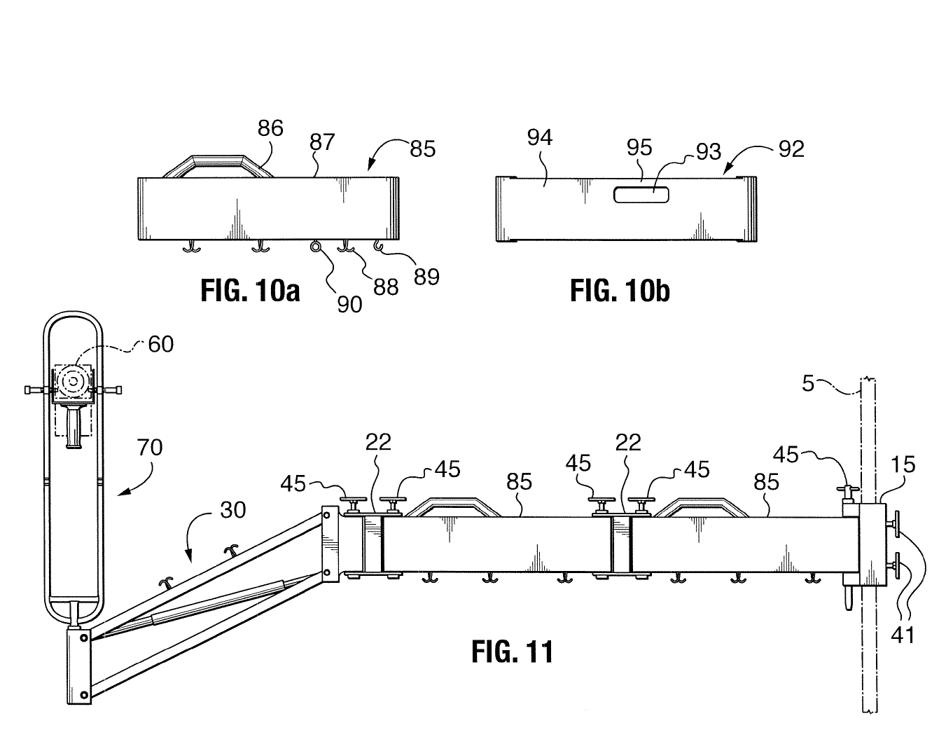

Another preferred embodiment provides spacer elements having carrying handles to further enhance portability of the articulating tool support of the present invention. FIG. 10a shows a spacer element 85 provided with a carrying handle 86 integrally connected to a top surface 87 of spacer element 85. FIG. 10b shows spacer element 92 having an elongated hole 93 therethrough adjacent spacer arm top surface 94 thereby providing a graspable handle portion 95.

Use of electric and pneumatic-powered hand tools on jobsites typically requires significant lengths of extension cords or pneumatic hoses to supply power to the hand power tools over extended distances. As the operators of such tools move about in three-dimensional workspaces, the distances between the power tools and the source of power vary constantly and considerably resulting in periods of time during which the lengths of extension cords or hoses are folded on themselves and/or are bunched on the floor surfaces whereon the operators are moving about thereby creating worker safety hazards. Yet another preferred embodiment of the present invention provides devices for passing through and retaining power cords and hoses close to the multiple components of the articulating tool support of the present invention as exemplified in FIG. 10a by discontinuous retainer loop 88, retainer hook 89, and continuous retainer loop 90 attached to bottom surface of spacer arm 85. However, it is to be understood that other types of retainers for power cords and hoses known to those skilled in this art are within the scope of this embodiment of the present invention. Furthermore, while the retainer devices of this embodiment are shown attached to the bottom surface of spacer arm 85, it is also within the scope of this invention to provide the retainer devices on the side surfaces and top surfaces of spacer arms if so desired.

The portable multi-component articulating support apparatus of the present invention can be partially or fully disassembled for transport to a job site, and then quickly assembled on site. This can be achieved by first securing mounting device 15 on a selected support element 5 such as a pole, post, pillar, column, and scaffolding. The support element may be an integral component of the work site or alternatively, portable in the form of an adjustable shoring pole designed to engage the floor and ceiling surfaces of a job site. Alternatively, the present invention may be fixed to a portable structural element having a collapsible framework as exemplified by scaffolding and a tripod. As shown in the preceding figures, the proximal end of spacer element 20 is detachably coupled to mounting device 15 with hinge pin 45, while the distal end of spacer element 20 is detachably coupled to one side of double-axis hinge element 22 with another hinge pin 45. The proximal bracket 31 of counter-balance element 30 is detachably coupled to the other side of double-axis hinge element 22 with another hinge pin 45. Tool-mounting bracket 60 is fitted to a power tool 61 by clamping device 65, after which the bracket is pivotingly engaged with a suitable tool holder as exemplified by tool holder 70 shown in FIGS. 6 and 7, and in tool holder 100 shown in FIGS. 12 and 13, by pin portions 69 of threaded bolts 68 pivotably communicating with opposing sleeves 73 or 103. The load-bearing shaft 72 of tool holder 70 (or alternatively, load-bearing shaft 102 of tool holder 100) is slidingly engaged with shaft receptacle 33 of the distal bracket 31 of counter-balance element 30.

An operator can easily and with minimal effort manipulate, orientate and operate power tool 61 throughout an entire three-dimensional workspace. This is possible because of vertical movement in a horizontal plane via the distal end of the counter-balance element 30, forward and backward movement permitted by the double-axis hinge element 22 and other rotation around hinge pins 45 that allows concertina-like folding of the support apparatus, as well as swivelling around the mounting device 15 and swivelling around vertical and horizontal axes permitted by the mounting arrangement of the tool holder 70. Such manipulation is facilitated by the counter-balancing of the weight of the tool by the counter-balance element 30 (which most preferably includes a gas-charged cylinder 36 having a pressure regulating valve to enable release or addition of compressed air/gas to enable adjustable weight balancing for a variety of power tools having different weights). Power tool 61 may be positioned in a 360° outward oriented horizontal plane by slidingly rotating load-bearing shaft 72 within shaft receptacle 33 of vertical control arm 30, and additionally, can be concurrently pivoted and oriented in a range of approximately 160° to 180° in vertical planes by pin portions 69 of threaded bolts 68 pivotingly communicating with tool cage sleeves 73.

The portable multiple-component support of the present invention can be quickly and easily disassembled by removing tool-mounting bracket 60 engaged with power tool 61, from tool holder 70, then removing tool holder 70 from counter-balance element proximal bracket 32, then removing all hinge pins 45, and finally, removing clamping device 15 from structural element 5.

It is to be noted that hinge pins 45 (or, in some embodiments, at least one and preferably two or more of them), are provided with enlarged upper ends having T-shaped handles that facilitate grasping and removal of the pins form their respective bores when disassembly is required. The enlarged upper ends stand proud of the elements that they connect and are therefore readily accessible, but are retained by gravity in the bores. The lower ends of the pins are not enlarged (and may be tapered) so that they do not resist removal from the bores when they are pulled upwardly during disassembly.

It is to be noted while the foregoing disclosure for the portable multi-component articulating tool support apparatus of the invention illustrates the use of a only one spacer element 20 and only one double-axis hinge element 22, it is also within the scope of the present invention to provide a plurality of such elements arranged in an alternating fashion to extend the maximum length of the apparatus. Such an arrangement having two spacer elements and two double-axis hinge elements is exemplified in FIG. 11.

While this invention has been described with respect to the preferred embodiments, it is to be understood that various alterations and modifications can be made to components of the portable articulating tool support within the scope of this invention, which are limited only by the scope of the appended claims.

1. A portable articulating support apparatus for supporting a hand-manipulated power tool while allowing movement of the tool in three dimensions, the apparatus comprising:
a tool holder capable of engaging and supporting a hand-operated power tool while allowing swivelling of said tool about horizontal and vertical axes, the tool holder having one end provided with a vertical load-bearing shaft configured for engaging and cooperating with a receptacle;
a counterbalance element having opposite ends, with one end detachably engagable with a double-axis hinge member and an opposite end provided with a receptacle configured for engaging and cooperating with the vertical load-bearing shaft, said opposite end being movable in a vertical plane while said one end is supported by said one hinge member, and having a balancing arrangement generating a force counteracting weight applied to said one end by said tool holder, said counterbalance configured to be lockable in downward extending, horizontal, and upward extending positions;
at least one spacer element having opposite ends, wherein each end is detachably engagable with a double-axis hinge member;
at least one double-axis hinge member having a pair of two opposed spaced-apart parallel bores therethrough for receiving a pair of hinge pins therein; and
a mounting device for the apparatus capable of disengageable attachment to a support element, the mounting device configured to detachably and hingeably engage one end of the spacer element;
wherein said counterbalance element, said at least one double-axis hinge member, said at least one spacer element, and said mounting device are arranged to form interconnecting parts of an articulating arm having said mounting device at one end of the articulating arm, said counterbalance element at an opposite end of the articulating arm, said at least one spacer elements detachably and hingeably engaged with said mounting device, and said at least one double-axis hinge members interposed said spacer element and said counterbalance element and detachably engaged therewith; and
a plurality of vertically disposed hinge pins passing through vertically aligned bores, including said spaced, parallel bores of said at least one double-axis hinge members, in said interconnecting parts of said articulating arm to allow pivotal rotation of said parts around said hinge pins, at least one of said hinge pins being slidably removable from one said bores and having an enlarged head at an upper end thereof shaped to be graspable by hand to facilitate complete removal of said pin, thereby allowing at least partial disassembly of said articulating arm for ease of transportation of said apparatus.

2. The apparatus of claim 1 having a plurality of spacer elements and a matching plurality of double-axis hinge members.

3. The apparatus of claim 1 wherein all of said hinge pins are slidably removable from said bores and all have enlarged heads at upper ends thereof shaped to be graspable by hand to facilitate complete removal of said pins from said bores.

4. The apparatus of claim 1 wherein said end of the counterbalance element detachably engagable with the double-axis hinge member, is configured to receive therethrough and engage therein a locking pin in a selectable position thereby selectably preventing movement of the opposite end of the counterbalance element in a vertical plane.

5. The apparatus of claim 1 wherein the tool holder comprises a tool-mounting bracket equipped with a tool-clamping device, the bracket being pivotally attached to a bracket support that allows the bracket to swivel around a horizontal axis, the bracket support having the vertical load-bearing shaft pivotally held by the receptacle of said counterbalance element while permitting swivelling of said tool holder about a vertical axis.

6. The apparatus of claim 5 wherein said bracket support comprises a frame rigidly attached at a lower end to said vertical load-bearing shaft and a pair of arms extending upwardly from said counterbalance element.

7. The apparatus of claim 4 wherein the bracket support extends downwardly from said counterbalance element and includes a universal joint interconnecting said tool-mounting bracket to said load-bearing shaft.

8. The apparatus of claim 4 wherein the tool-mounting bracket comprises opposing plates integrally connected to a bottom plate, the bottom plate having a bore receiving a part of said tool-clamping device for securing a power tool.

9. The apparatus of claim 8 wherein the opposing plates are provided with a pair of aligned opposing bores pivotally receiving supporting bolts attached to said bracket support.

10. The apparatus of claim 9 wherein the opposing plates are provided with a plurality of said aligned opposed bores.

11. The apparatus of claim 4 wherein the tool-mounting bracket comprises:
a pair of opposing plates integrally connected to a bottom plate,
a first clamping device engaged with the opposing mounting plates in a first selected plane; and
a second clamping device engaged with the opposing mounting plates in a second selected plane orientated at about 90° to the first selected plane;
wherein said first and second clamping devices are configured to cooperatively demountably engage and retain a tool therein said tool-mounting bracket.

12. The apparatus of claim 11 wherein first and second clamping devices each comprise:
a strap mounted by one end to one of said opposing plates;
a lever hingedly connected to the other end of said strap;
a biasing device having a first end cooperatively mountable onto the lever;
a receiving plate configured for releasably engaging and retaining therein a second end of said biasing device;
wherein said lever is movable between an unlocked position whereby the second end of said biasing device is removable from said receiving plate, and a locked position wherein said second end of said biasing device is retained and engaged by said receiving plate thereby providing a clamping force.

13. The apparatus of claim 1 wherein said at least one double-axis hinge member comprises an upper elongate plate integrally connected by a web to a lower elongate plate, and wherein said spaced, parallel bores pass through the upper and lower elongate plates on either side of the web.

14. The apparatus of claim 1 wherein said at least one spacer arm is provided with a plurality of retaining devices for a power cord.

15. The apparatus of claim 1 wherein the counterbalance element is provided with a plurality of retaining devices for a power cord.

16. The apparatus of claim 1 wherein said counterbalancing arrangement of said counterbalance arm comprises a gas-charged cylinder.

17. The apparatus of claim 16 wherein the gas-charged cylinder is provided with a valve for facilitating adjustment of gas pressure therein.

18. A portable articulating support apparatus for supporting a hand-operated power tool while allowing movement of the tool in three dimensions, the apparatus comprising:
a tool holder capable of engaging and supporting a hand-operated power tool while allowing swivelling of said tool about horizontal and vertical axes, the tool holder having one end provided with a load-bearing shaft configured for engaging and cooperating with a receptacle;
a tool-mounting bracket configured for cooperating engagement with said tool holder, the tool-mounting bracket comprising a pair of opposing plates integrally connected to a bottom plate, a first clamping device engaged with the opposing mounting plates in a first selected plane, and a second clamping device engaged with the opposing mounting plates in a second selected plane orientated at about 90° to the first selected plane, wherein said first and second clamping devices are configured to cooperatively demountably engage and retain a tool therein said tool-mounting bracket.
a counterbalance arm having opposite ends, with one end detachably engagable with a double-axis hinge member and an opposite end provided with a receptacle configured for engaging and cooperating with the load-bearing shaft, said opposite end being movable in a vertical plane while said one end is supported by said one hinge member, and having a balancing arrangement generating a force counteracting weight applied to said one end by said tool holder, said counterbalance configured to be lockable in downward extending, horizontal, and upward extending positions;
at least one spacer element having opposite ends, wherein each end is detachably engagable with a double-axis hinge member;
a double-axis hinge member having two sets of juxtaposed bores wherein each set of juxtaposed bores is configured for receiving a hinge pin therethrough;
a mounting device capable of disengageable attachment to a support element, the mounting device configured to detachably and hingeably engage one end of the spacer element;
wherein said counterbalance element, said at least one double-axis hinge member, said at least one spacer element, and said mounting device, are detachably and rotatably engaged one with another by a plurality of removable vertically disposed hinge pins passing through vertically aligned bores in overlapping parts of said counterbalance element, said at least one double-axis hinge member, said at least one spacer element, and said mounting device, said removable hinge pins having enlarged heads at upper ends thereof shaped to be graspable by hand to facilitate complete removal of the pins from said bores, thereby allowing separation of said counterbalance element, said at least one double-axis hinge member, said at least one spacer element, and said mounting device for ease of replacement, storage and transport thereof.
